(19) United States
(12) Patent Application Publication
(10) Pub. No.: US 2025/0152456 A1
(43) Pub. Date: May 15, 2025

(54) Adjustable Myofascial Foam Roller Exercise Apparatus

(71) Applicant: Ronald Cuthbert Aigle, Jersey City, NJ (US)

(72) Inventor: Ronald Cuthbert Aigle, Jersey City, NJ (US)

(21) Appl. No.: 18/509,621

(22) Filed: Nov. 15, 2023

(51) Int. Cl. A61H 15/00

(52) U.S. Cl. CPC A61H 15/00; A61H 2015/0014; A61H 2201/0192; A61H 2201/1253; A61H 2201/1633; A61H 2201/1635; A61H 2201/1664; A61H 2201/1685; A61H 2201/169

(57) ABSTRACT

The present invention discloses a multifunctional, telescopically adjustable, tubal, rectangular exercise and therapeutic myofascial apparatus for treating a person's musculature. The apparatus aids in the relief of muscle tension by simultaneously utilizing the roller and body gliding seat. Embodiments of the present invention include a frame, a sliding seat, two parallel hand grips towards the front, and a cylindrical elongated high-density roller of a selective material and diameter extending through the width of the parallel elongated tubular structure affixed to the rear portion. Linear bearings are enclosed in parallel tubes, which serve as the glider function of the seat stabilizer. Users roll back and forth on the seat stabilizer while rolling an appendage, spine, or other body parts on the high-density foam roller.

### TECHNICAL BACKGROUND

The disclosed invention relates to the technical field of portable fitness equipment, non-invasive therapeutic devices, and Occupational Therapists (OT) or Physical Therapist (PT) tools, particularly a telescopically adjustable, multifunctional myofascial roller with a gliding body stabilizing seat, an interchangeable high-density roller on one end, and two parallel handles for ease of use, comfort, stability, and support on the other end.

### FIELD OF INVENTION

The present invention generally relates to a portable fitness apparatus that utilizes self-myofascial or OT/PT guidance to aid in the connective tissue release of the regions of the leg, arms, shoulders and back induced by rolling to benefit the recovery of muscles that are stressed or aching resulting in a lack of mobility. The non-invasive therapeutic device is to be used on muscles, ligaments, and tendons. In general, rolling devices made of foam and other materials allow users to target muscle areas using their body weight to massage and remove any muscle restrictions.

Utilizing the full scope of the apparatus increases blood flow in tissues to increase oxygen and nutrient absorption. In particular, the present invention provides an adjustable rectangular-shaped tubular frame with parallel handles on one end and a high-density roller of a selective material and diameter on the other. One main object of the present invention is to improve the user's mobility.

The invention aims to provide a multifunctional myofascial exercise apparatus with two handles for stability and comfort and an affixed high-density roller of a selective material with a body gliding seat that offers several exercises at any time. In addition, the invention may have optional detachable resistance bands for general exercise, stretching, and strength training.

### BACKGROUND OF INVENTION

Countless medical and scientific studies have shown the benefits of physical activity. Although exercise is great for your body, mind, and spirit, exercise induces micro-tears and swelling in muscle fibers, which impinge on nerves and vessels. Over time, the tears can develop into adhesions and scar tissue. Foam rolling and flexibility exercise helps smooth out the scar tissue and break down the adhesions to increase blood flow within the muscle and surrounding connective tissue.

When users engage in foam or other conducive material for rolling, they utilize a self-myofascial and connective tissue release technique to help recover muscles that are stressed, overactive, or have developed scar tissue. Fascia is the soft portion of the muscle's connective tissue that provides support and protection.

Many people, regardless of age, have poor blood circulation and skeletal alignment. Those dealing with poor circulation have pain, poor healing, reduced flexibility and range of motion, and numb appendages. Today, there are many apparatuses for blood circulation stimulation and alignment. The clear disadvantage of the apparatuses available in the marketplace is that they do not work with connective tissues, nor can they reach critical areas to provide effective and corrective relief.

It is thus the object of the present invention to provide a simple apparatus that is new and improved with multiple connective tissue approaches that are easy to use for a single user or users with limited mobility with the aid of OTs.

The present invention's method of rolling back and forth on the roller stimulates blood vessels and improves blood circulation. Over time, the use of the apparatus promotes the flow of blood to add oxygen and nutrients for muscle and connective tissue ailments. Overall, it is the object of the present invention to improve the user's quality of life by strengthening joints, ankles, and knees.

### SUMMARY OF THE INVENTION

An embodiment of the present invention's portable tubal rectangular frame measures 20×48 with a ¼-inch bar to securely hold a high-density roller of a specified material and diameter. The high-density roller is interchangeable to accommodate various diameters.

Per another aspect of the present invention, weighted resistance bands with a simple hook coupling mechanism are attached to the parallel handle on the opposite end of the roller bar or the tubing at the bottom.

Another embodiment of the present invention may consist of a moveable and removable body gliding seat to be used as a balance pad that will be easily detachable and made of foam or a conducive material. The seat will rest on a track coupled to the bearing rail or sleeve. The seating will consist of a comfortable, lightweight, moisture and slip-resistant material. The removable seat will be ideal for exercise and balance/stability training based on the user's desired exercise needs.

In another embodiment of the present invention's tubular rectangular frame, the length and width sides of the parallel tubes on opposing ends of the apparatus are telescopically adjustable to allow the user or OT/PT to comfortably utilize the high-density roller based on the body size of the user as intended.

There are several common plastics suitable for bearings such as Phenolics, Acetals, Nylon, UHMWPE (Ultrahigh-Molecular-Weight and PTFE (Polytetrafluoroethylene) which can be utilized in manufacturing the present invention to offer life-long wear and tear.

In this respect, before explaining at least one embodiment of the invention in detail, it is understood that the invention is not limited in its application to the construction details and the arrangements of the components outlined in the following description or illustrated in the drawings. The invention is capable of embodiments in addition to those described and of being practiced and carried out in various ways. Also, it is understood that the phraseology and terminology employed herein and the abstract are for description and should not be considered limiting.

As such, those skilled in the art will appreciate that the conception upon which this disclosure is based may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The drawings presented in this method are provided in general terms, illustrate an embodiment of the invention and serve to explain key principles of the invention. In the drawing:

FIG. 1 is a perspective view of an embodiment of the present invention.

FIG. 2 is a bottom view of an embodiment of the present invention.

FIG. 3 is a top view of an embodiment of the present invention.

FIG. 4 is a side view of an embodiment of the present invention, showing a user performing a calve roll.

FIG. 5 is a side view of an embodiment of the present invention showing a user performing a quads roll.

FIG. 6 is a top view of an embodiment of the present invention showing the adjustable width.

FIG. 7 is a top view of an embodiment of the present invention showing the adjustable length.

FIG. 8 is a perspective view of another embodiment of the present invention.

FIG. 9 is a top view of an embodiment of the present invention.

FIG. 10 is a top view of another embodiment of the present invention showing the adjustable width.

FIG. 11 is a top view of another embodiment of the present invention showing the adjustable length,

FIG. 12 is a front view of another embodiment of the present invention selected roller diameter.

FIG. 13 is a front view of another embodiment of the present invention selected roller diameter.

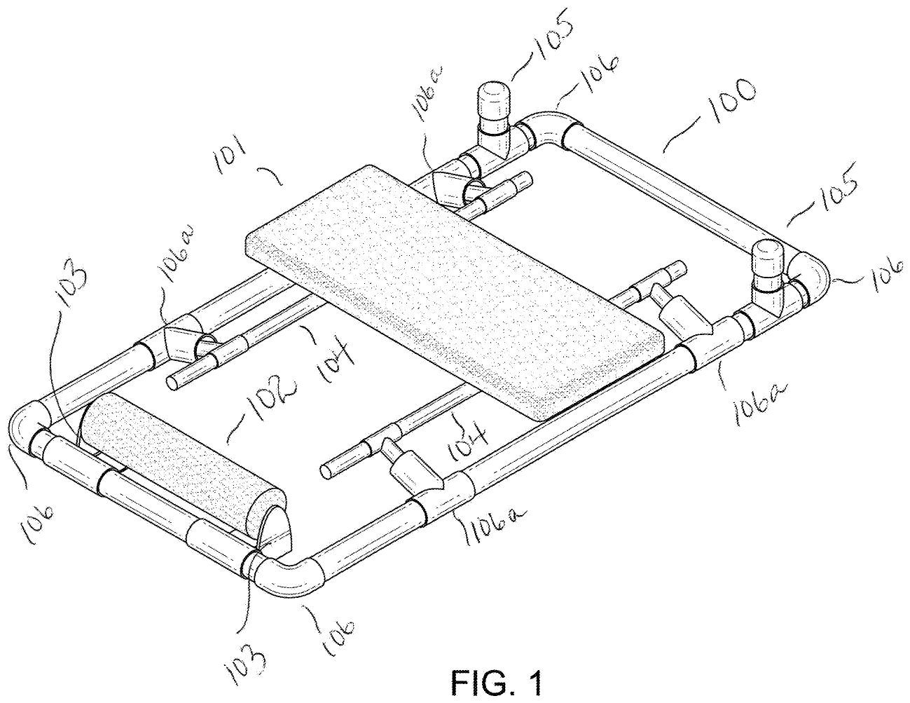

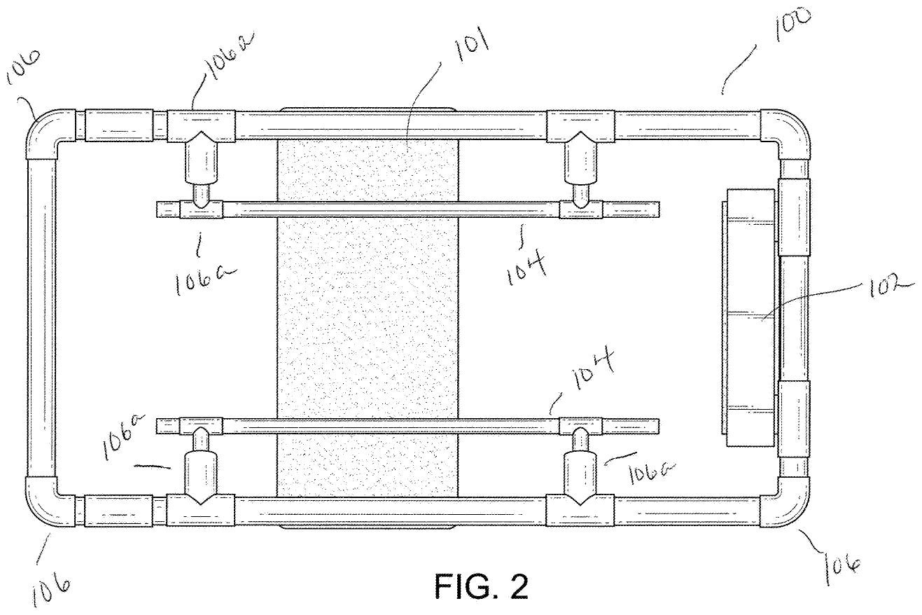

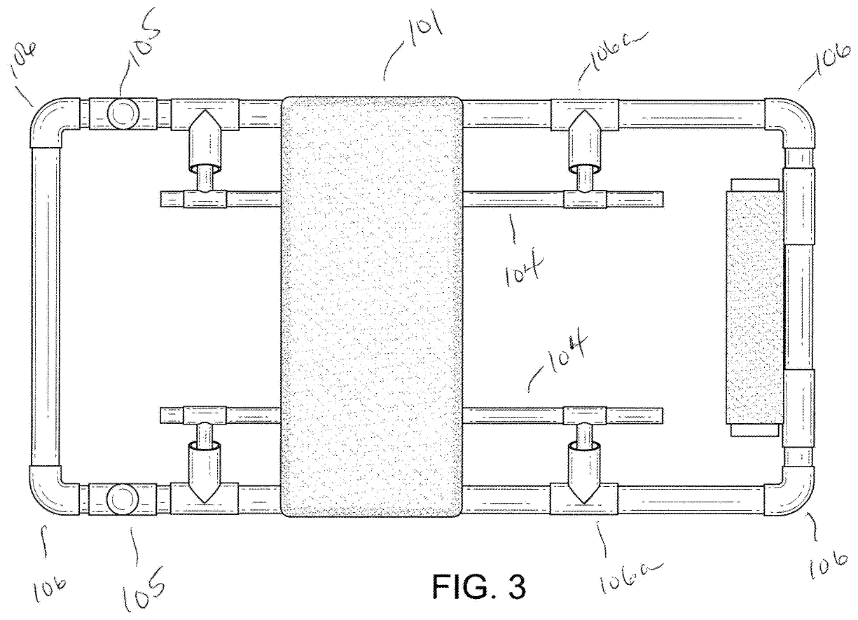

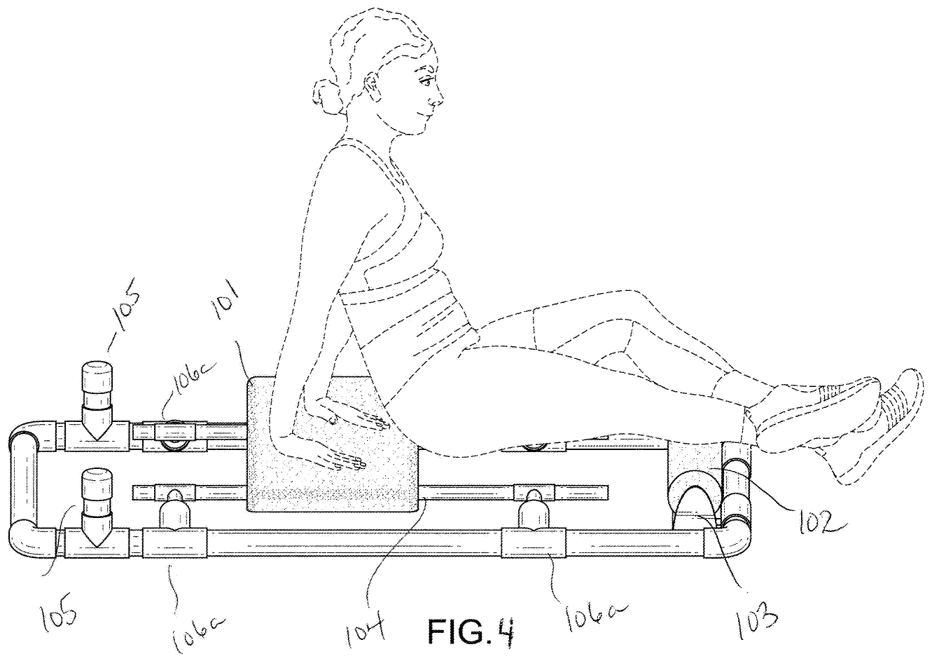

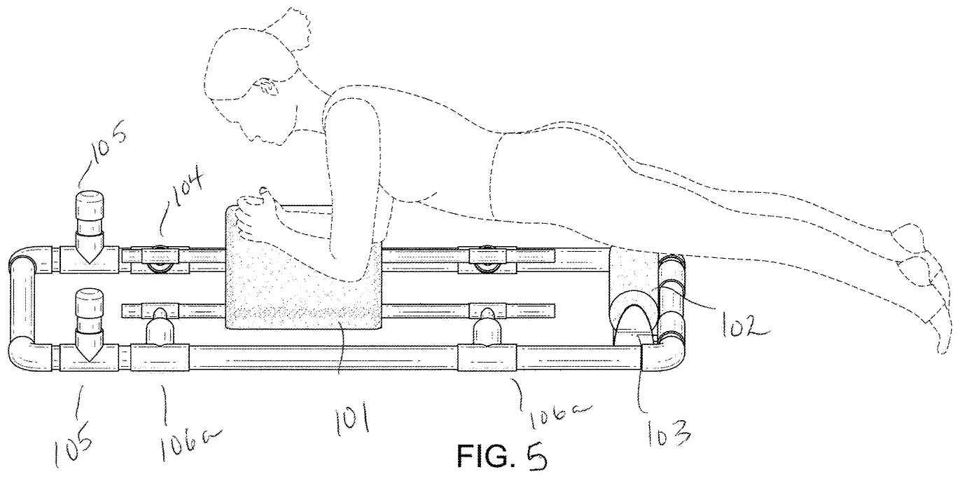

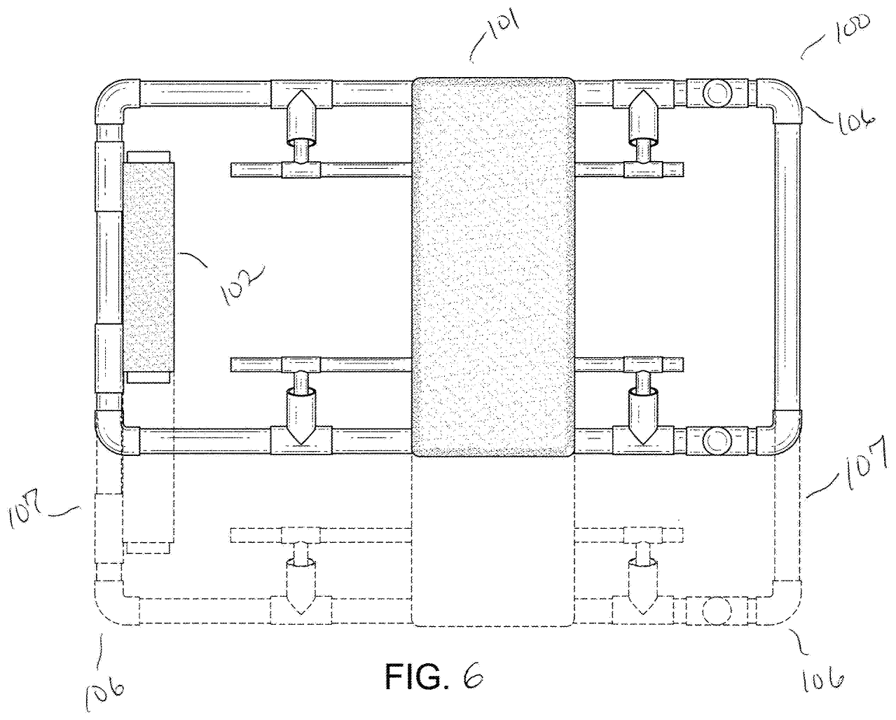

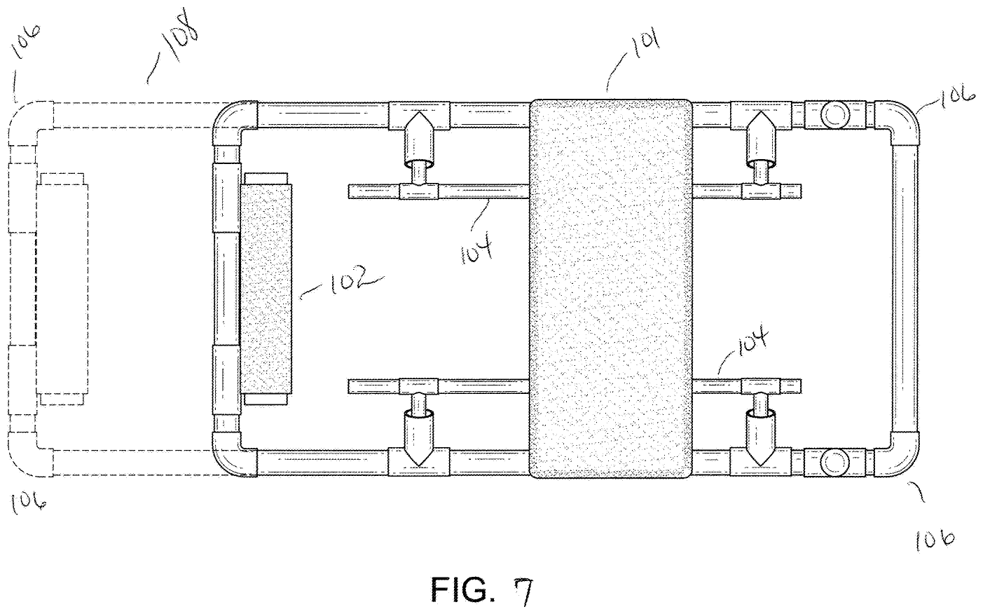

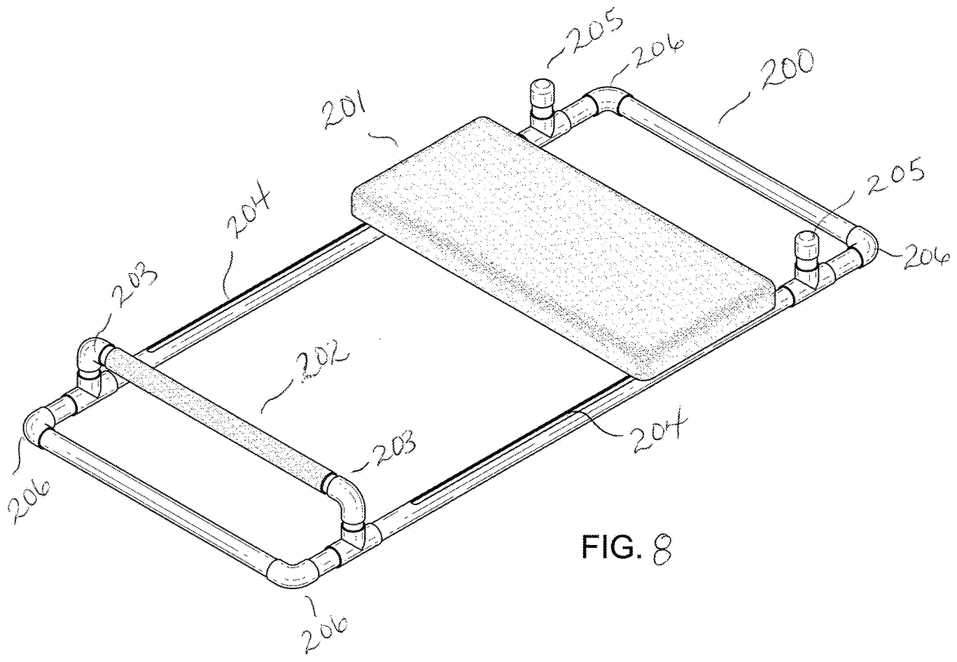

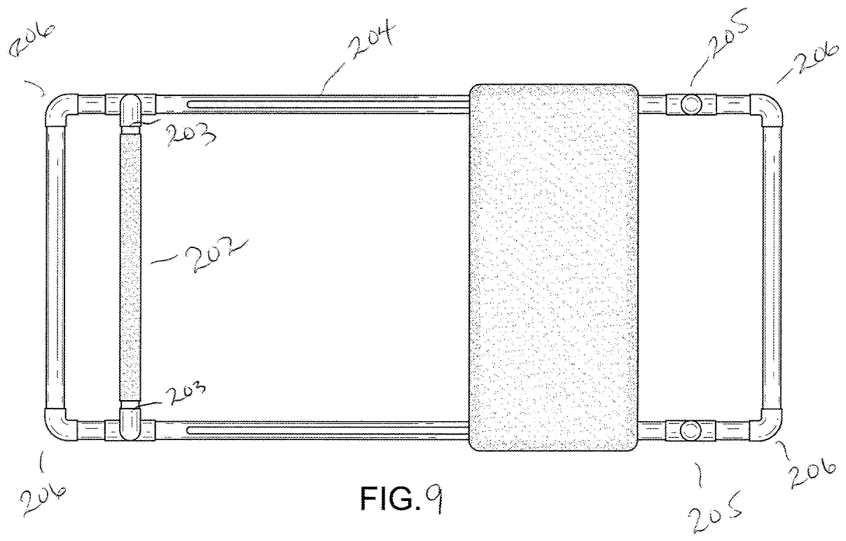

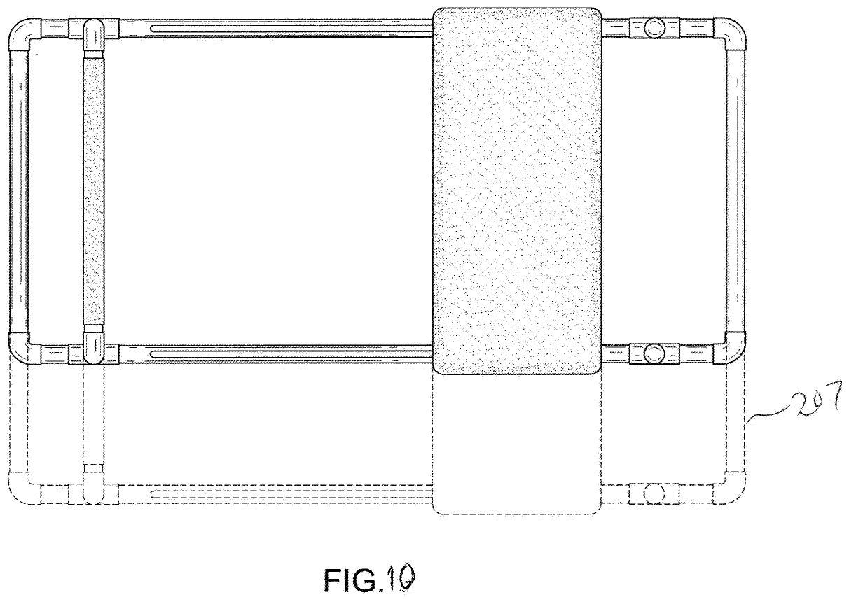

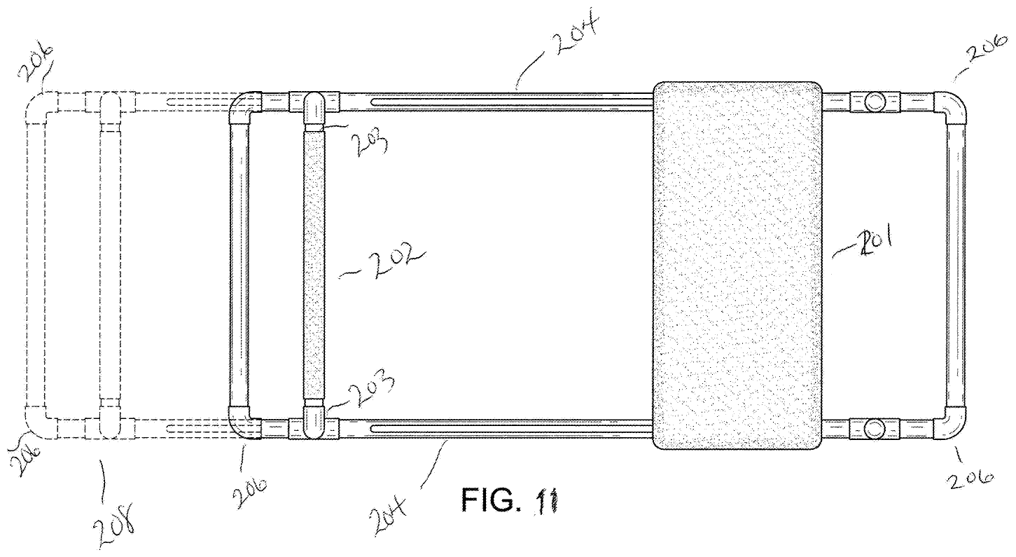

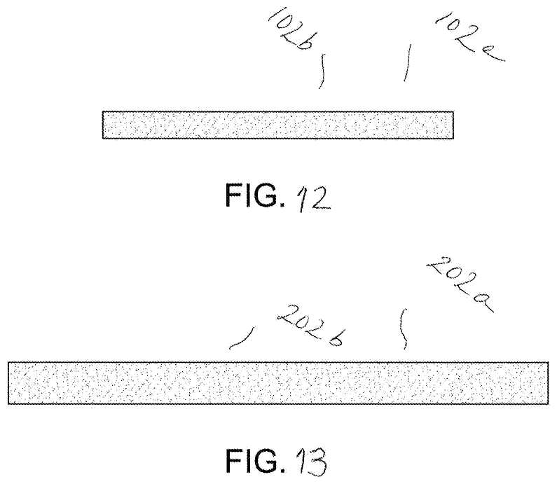

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown but is to be accorded the widest scope consistent with the principles and features disclosed or suggested herein.

The subject matter disclosed herein is directed to an improved adjustable 107, 108, 207, 208 and portable myofascial release roller device 100, 200 to improve mobility while supporting the user's body weight in its application. The improved adjustable roller device 100, 200 includes a tubular rectangular construct with a moveable seat 101, 201 and/or body glider to glide the user's body back and forth. Linear struts and bearings 104, 204 or sleeves may be utilized to provide the gliding motion. A high-density foam or urethane 102, 202 roller on one end and parallel handles 105, 205 on the other.

The present invention utilizes a coupling mechanism 106, 206 to secure the four edges of the tubular construct, two attachments 103, 203 configured to secure the high-density 102, 202 foam or urethane roller, and two attachments 105, 205 configured to secure the parallel handles. The base consists of rectangular or circular 106c strips of durable non-slip material affixed via adhesive to each coupling mechanism.

The method includes supporting the user's upper body by lying or sitting on the 101, 201 seat or body glider to roll back and forth 104, 204 creating a myofascial release through sustained pressure to loosen and lengthen constricted fascia areas on the 100, 200 apparatus. Areas include but are not limited to quadriceps, hamstrings, calves and ankles, gluteus maximus, upper and lower back, forearm, and triceps.

The method also includes lying face down on the 101, 201 seat or body glider with arms extended on the 102, 202 roller to massage the triceps and forearms on the device. Users can switch arms as necessary.

In an exemplary embodiment, an object of the present invention 100, 200 is to provide for the myofascial release of the calves 102. Users sit on the 101, 201 seat or body glider with legs fully extended. Hands should be placed 105, 205 behind to grasp the handles for balance. Place the right calf on the 102, 201, 102a, 102b, 202a, 202b roller and with the left leg fully extended, place it over the right knee for applied pressure. Roll the calf or ankle area back and forth on the 102, 201, 102a, 102b, 202a, 202b roller. Repeat on the opposite leg as necessary.

An object of the present invention 100 is to provide for the myofascial release in the hamstrings. Users sit on the 101 seat or body glider. Place the right leg on the 102a, 102b roller, left knee bent, and hands behind to grasp the 105 handles. Roll back and forth 104 from the knee to under your right gluteus maximus. Switch legs.

Another object of the present invention 100, 200 is to provide for the myofascial release in the quadriceps. Users lie face down on the 101, 201 seat or body glider from chest to stomach. Place hands on the 105, 205 parallel handles or on the 104, 204 device frame. Position the high-density 102, 202, 102 a, 102b foam or urethane roller. At the center, then roll the quadriceps back and 102, 202, 102a, 102b forth from hip to knees. Then turn slightly to the side to engage the iliotibial band (IT Band). Switch legs as necessary.

In another embodiment, the object of 100, 200 the present invention is to provide for the myofascial release of the gluteus maximus by sitting on the 101, 201 seat or body glider with knees bent and feet on the floor, 104, 204 rolling back and forth with user's posterior slightly reclined and hands on the floor.

Another object of the 100, 200 invention is to provide the myofascial release of the upper and lower back. Users lay in a supine position with shoulders (upper back) on the 101, 201 seat or body glider and lower back on the 102, 202, 102a, 102b roller. Knees are bent with feet on the floor, 104, 204 moving back and forth. For the upper back, place shoulders on the 102, 202, 102a, 102b roller with glutes on the 101, 201 seat or body glider, knees bent and feet on the floor and 104, 204 move back and forth.

### DESCRIPTION OF PRIOR ART

Over the past few years, rolling devices constructed of foam and other materials have become popular for consumer use. However, most personal and OT/PT rolling devices are ineffective due to their embedded designs and shapes on the roller. Most foam roller devices of this nature will take considerably longer to provide the desired user result of a better quality of life and mobility. The smoother and denser rolling devices provided effective results in less time. The present invention uses a dense roller of an appropriate diameter and material in a preferred embodiment. More importantly, the present invention utilizes a device to make foam rolling easier and more comfortable.

Furthermore, the present invention is truly innovative in that there is no adequate prior art to compare and contrast to the present invention. With this in mind, the prior art represented below mainly relates to self-administered foam rollers in general and rowing machines in general as rowing machines have a similar sliding moving member seat on a track.

U.S. patent Ser. No. D657,830 to G2 Lifestyles LLC provides an exercise roller depicting roller exercises affixed to the roller. Although we do not know the size or materials used in designing this foam roller, it is critical to note that all of the exercises disclosed on the foam roller can be accomplished with ease and comfort as described in the present invention.

U.S. patent Ser. No. 11/141,345 to Kyriacou et al. discloses a portable roller device with several layers of different textures coupled to the rolling tube. The Kyriacou invention intends to provide users with different tension experiences based on the textured layer in use. However, the various textures are less effective and take longer for the user to achieve the desired results. The present invention offers a smooth roller feature and a comfortable seat to glide back and forth as users easily release myofascial tissue on various body parts.

U.S. Pat. No. 9,463,133 to Rogers presents a deep tissue massage roller in a cylindrical shape with two opposing V-shaped and Y-shaped ridges. This device is similar to other foam rollers in that the user must roll the device across their body, whereas the present invention allows the user to movably glide along in a seated position and roll an appendage on an attached roller. The present invention provides an effortless exercise as opposed to standard foam rollers.

U.S. Pat. No. 9,623,283 to Vallo et al. discloses an exercise roller device with removably fixable support. The Vallo device is problematic in that it is shaped similarly to a saw stand with the foam roller in the center connecting at each end. This device can cause users injury based on their height and other weight and mobility factors. Users will have to lean into the device to massage upper appendages, which will also cause injury. More importantly, the device is unstable and will move once pressure is applied.

U.S. Pat. No. 10,039,690 to Kramer presents a dual muscle roller that has two rollers connected to two upright handles. The user places the device between one leg and moves the handles up and down for the rollers to press against the legs. This device is very limited in massaging other appendages.

While the present disclosure has been described in one or more embodiments, it is understood that these embodiments are illustrative and that the scope of the disclosure is not limited to them. Many variations, modifications, additions, and improvements are possible.

For the foregoing reasons, the present invention is needed in the marketplace. A preferred embodiment uses advanced engineered plastic polymers and composites for performance advantages over metal and other materials. These new polymers are self-lubricating with lower friction and allow plane bearings work effectively and effortlessly for the gliding/moveable seat.

### Current U.S. Classifications

### A61H: 1/1001; 1/003; 1/005

15/00; 2015/0014
1/02; 2001/0251;
7/002; 7/003

Patent Citations

| | | |
|---|---|---|
| 9,463,133 | October 2016 | Rogers |
| 9,623,283 | April 2017 | Vallo et al. |
| 10,039,690 | August 2018 | Kramer |
| 10,279,214 | May 2019 | Chiang et al. |

What is claimed is:

1. A system for a myofascial tissue release exercise apparatus comprising:
a. a frame having a tubal rectangular shape as a base, interconnected with coupling at each of the four corners;
b. a rectangular gliding seat using linear struts and bearings to move user's back and forth to engage in the tissue release exercises;
c. two attachments configured to secure the high-density foam roller;
d. a foam or urethane roller on one end; and
d. two parallel handle grips wherein the handle portions are cylindrical handle portions at the rear of the device and secured to the frame.

2. The system of claim 1 wherein the base is telescopically adjustable to increase both length and width.

3. The system of claim 1, wherein said foam or urethane roller is interchangeable.

4. The system of claim 1, wherein said gliding seat or sliding member is removable.
a. a system in claim 4, wherein the sliding member is movably disposed simultaneously on each of the two tracks.
b. a system in claim 4, wherein the sliding member is movably disposed simultaneously on each side of the system frame.
